(19) United States
(12) Patent Application Publication
(10) Pub. No.: US 2003/0131681 A1
(43) Pub. Date: Jul. 17, 2003

(54) Steering wheel of vehicle

(76) Inventor: Hong-Jiun Gu, Taipei (TW)

Correspondence Address: Hong-Jiun GU, P.O. Box No.6-57, Chung-Ho, Taipei, 235, TW

(21) Appl. No.: 10/042,327

(22) Filed: Jan. 11, 2002

(51) Int. Cl. B62D 1/04

(52) U.S. Cl. 74/552

(57) ABSTRACT

An improved steering wheel of vehicle comprises an annular shape handle connected with a central hub through a plurality of radial bars. The annular shape handle comprises a left handgrip, a right handgrip, an upper handgrip and a lower handgrip occupying four quadrants of the annular shape handle. Two bumps are arranged somewhat at 10 o'clock and 10 minutes positions of the steering wheel; and two skidproof dents are formed below the two bumps.

### BACKGROUND OF THE INVENTION

The conventional steering wheel of vehicle generally comprises an annulus handle connected to a hub through a plurality of supporting radial bars. The hub is linked to the steering rack of the vehicle to control moving direction of vehicle.

The conventional steering wheel has ring-shape handle, therefore, the driver has the same tactile feeling at any rotatory angle. Conventionally the torque force is amplified through a worm and a worm wheel. Moreover, the steering wheel transmits power in a mechanical way and in circular movement. The driver of the car should exert considerable strength to rotate the annulus handle for turning the car. The power steering wheel is developed to overcome the problem, wherein an oil-pressure system is used to assist the turning of the handle. The oil-pressure system senses the turning direction of the handle and generates power to assist the turning operation. By the oil-pressure system, the driver can perform turning operation by single hand. The driver generally tucks one of his hands and one dent portion is naturally formed in the palm of the tucked hand. The dent portion has certain friction to drag the handle.

Moreover, an assisting means to facilitate turning car is developed. This means is similar to the handle of a forklift and comprises a rolling ball locked to a portion of the handle though a link member. The above-mentioned assisting means is especially useful when driving in winding lane. However, the above-mentioned assisting means is additionally arranged and liable to loose.

As can be seen from above description, the developing trend of the steering wheel is to facilitate single-hand operation due to the help of the oil-pressure system. However, the handle generally has circular contour such that the hand of driver may be skidded.

### SUMMARY OF THE INVENTION

Therefore, it is the object of the present invention to provide an improved steering wheel of vehicle, which integrally has means to enable the drive to turn a car with single hand and the problem of skidding is overcome.

To achieve the above-mentioned object, the present invention provides a steering wheel characterized in that two bumps are arranged somewhat at 10 o'clock and 10 minutes positions of the steering wheel, and two skidproof dents are formed below the two bumps.

The various objects and advantages of the present invention will be more readily understood from the following detailed description when read in conjunction with the appended drawing, in which:

### BRIEF DESCRIPTION OF DRAWINGS

FIG. 1 shows a top view of the present invention;

FIG. 2 shows a sectional view of the present invention;

FIG. 3 is a schematic view of the application of the present invention;

FIG. 4 shows another preferred embodiment of the present invention; and

FIG. 5 shows still another preferred embodiment of the present invention.

### DETAIL DESCRIPTION OF PREFERRED EMBODIMENTS

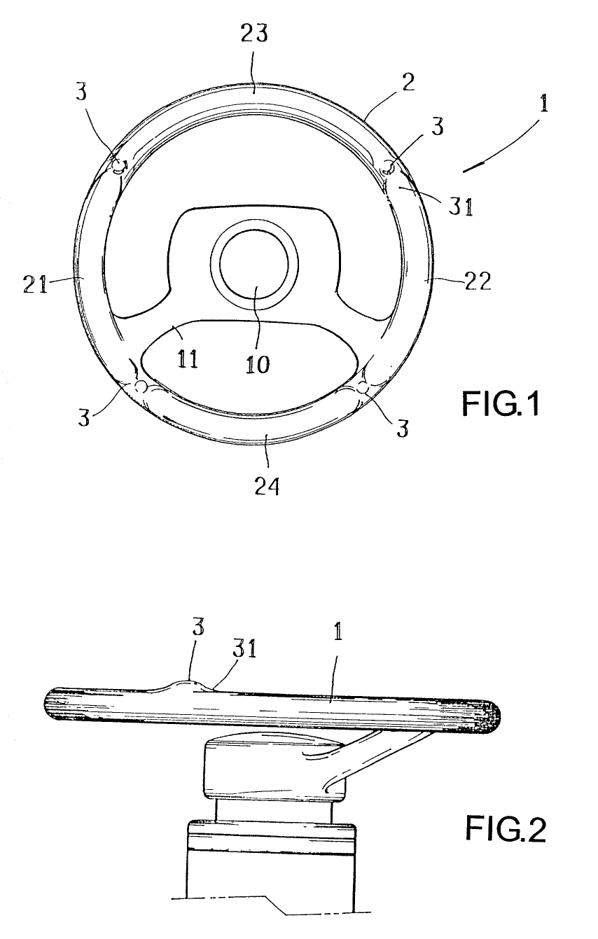

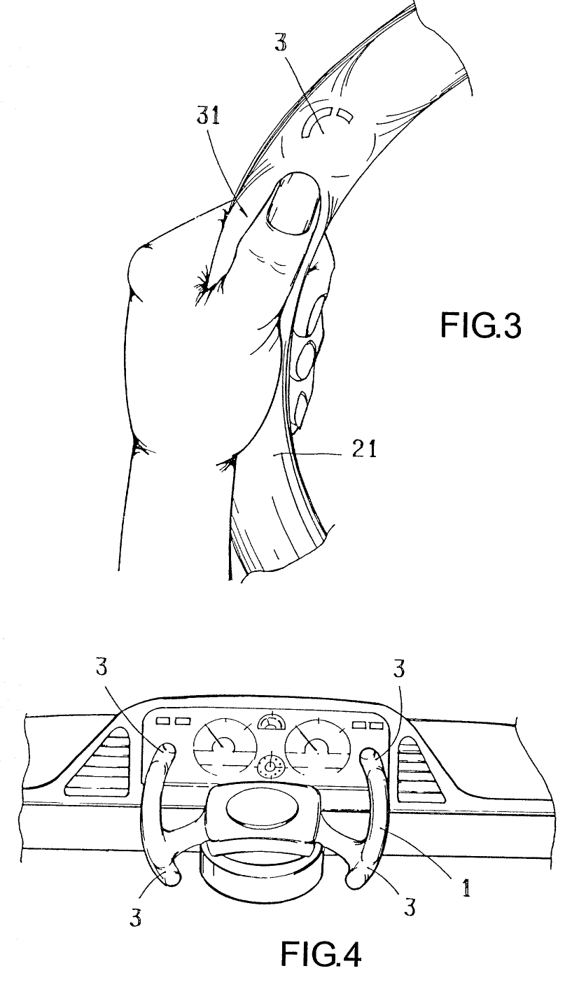

As shown in FIG. 1, the improved steering wheel 1 of the present invention comprises an annular handle 2 connected with a hub 10 through radial bars 11. The annular shape handle 2 comprises a left handgrip 21, a right handgrip 22, an upper handgrip 23 and a lower handgrip 24 occupying four quadrants of the annular handle 2. The upper portions of the left handgrip 21 and the right handgrip 22 each have a circular bump 3. As shown in FIGS. 2 and 3, the circular bumps 3 of the left handgrip 21 and the right handgrip 22 are arranged somewhat at 10 o'clock and 10 minutes positions. A skidproof dent 31 is provided below each bump 3. The driver can place his thumb within the dent 31 when his palm is tucked to hold the bump 3. The bump 3 preferably has circular shape such that the user has same tactile feeling at any turning angle.

The security of the present invention for single-hand steering can be manifested from the operation of forklift. The handle of a forklift and comprises a rolling ball locked to a portion of the handle though a link member. The assisting means for single-hand steering is especially useful when driving in winding lane or at low speed.

More particularly, in the present invention, a skidproof dent 31 is provided below each bump 3 on the left handgrip 21 and the right handgrip 22 to facilitate the handling of the steering wheel 1.

More particularly, the bumps 3 are located with the hub 10 as a center to facilitate the operation of user.

In another aspect of the present invention, the upper handgrip 23 and the lower handgrip 24 can be removed from the wheel shown in FIG. 1, thus forming a W-shape “wheel” as shown in FIG. 4. Therefore, only the left handgrip 21 and the right handgrip 22 are used to steer the car. More particularly, for turning a larger angle, the bumps 3 on the left handgrip 21 and the right handgrip 22 can be used, for linear motion or high-speed driving, the left handgrip 21 and the right handgrip 22 are sufficient and the upper handgrip 23 and the lower handgrip 24 can be eliminated. The conventional steering wheel should be rotated larger angle to turn the car because the larger gear ratio. In modern car with oil-pressure system, the wheel has same rotating angle as turning angle of the car, therefore, a wheel with only the left handgrip 21 and the right handgrip 22 as shown in FIG. 4 is sufficient. For example, the new car of SAAB is steered by a control joystick, which has rotation angle same as the turning angle of the car. Moreover, according to the experiment of SAAB company, the control joystick is also easy for beginner.

FIG. 4 shows another preferred embodiment of the present invention. The driver can directly view the instrumental panel due to the removal of the upper handgrip 23 and the lower handgrip 24. In still another preferred embodiment of the present invention, the steering wheel has predominantly only left handgrip 21 and the right handgrip 22; the upper handgrip 23 and the lower handgrip 24 can be assembled to the steering wheel with only left handgrip 21 and the right handgrip 22 to form a round steering wheel. The assembling can be conventional way such as locking or engaging and will not be described in detail here.

In modern car design, the steering system has similar strategy as the steering stick of SAAB. The car can be effectively turned by only swinging 60 total degrees (left side: 30 degrees; right side: 30 degrees). Therefore, the steering wheel with only left handgrip 21 and the right handgrip 22 is sufficient.

In the present invention, the steering wheel 1 is still arranged at the hub of the steering rack of the vehicle, which is different to the control joystick proposed by SAAB company and arranged at the central console. Therefore, it will be more natural for the driver to use the inventive steering wheel 1 than the control joystick proposed by SAAB company. More particularly, the inventive steering wheel 1 is arranged along the same line of sight as the front windshield. Therefore, the inventive steering wheel 1 is more convenient and safer for driver.

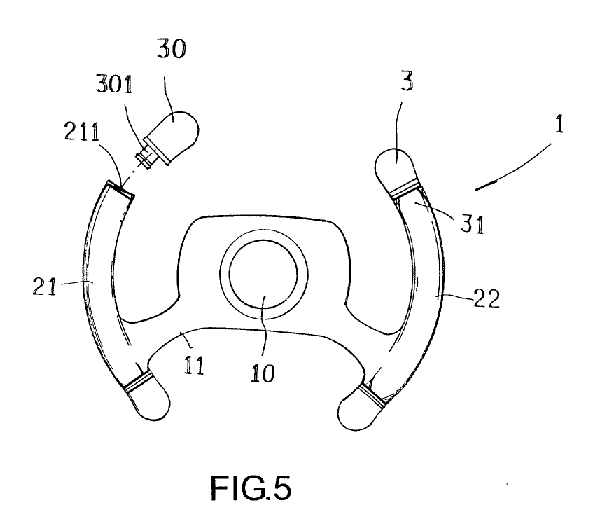

FIG. 5 shows still another preferred embodiment of the present invention. The bumps 3 can be detachably arranged on distal ends of the left handgrip 21 and the right handgrip 22. The bump 3 comprises a bump body 30 with a connecting part 301 on one side thereof. Correspondingly, the left handgrip 21 has a mating part 211 assembled to the connecting part 301. The right handgrip 22 has also a mating part (not shown) assembled to the connecting part 301.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. An improved steering wheel of vehicle comprises an annular handle connected with a central hub through a plurality of radial bars; the annular shape handle comprising a left handgrip, a right handgrip, an upper handgrip and a lower handgrip occupying four quadrants of the annular shape handle;
the steering wheel characterized in that two upper bumps are arranged at 10 o'clock and 10 minutes positions of the steering wheel.

2. The improved steering wheel of vehicle as in claim 1, further comprising two skidproof dents formed below the two bumps.

3. The improved steering wheel of vehicle as in claim 1, further comprising two bumps on lower side of the steering wheel and symmetry with upper bumps.

4. The improved steering wheel of vehicle as in claim 1, wherein the upper handgrip and the lower handgrip are removed from the steering wheel.

5. The improved steering wheel of vehicle as in claim 1 and 3, wherein the upper handgrip and the lower handgrip are detachably assembled to the steering wheel.

6. The improved steering wheel of vehicle as in claim 1, wherein the upper bumps are detachably assembled to the steering wheel.
